(19) United States
(12) Patent Application Publication
(10) Pub. No.: US 2010/0259612 A1
(43) Pub. Date: Oct. 14, 2010

(54) Control Module For Video Surveillance Device

(75) Inventors: Lars Christian, Hamburg (DE); Candice Lin, Taipei (TW)

Correspondence Address: SCHMEISER OLSEN & WATTS, 18 E UNIVERSITY DRIVE, SUITE # 101, MESA, AZ, 85201, US

(73) Assignees: Lars Christian, Hamburg (DE); AEviso Video Solution Co., Ltd., Taipei (TW)

(21) Appl. No.: 12/421,326

(22) Filed: Apr. 9, 2009

(51) Int. Cl. H04N 7/18

(52) U.S. Cl. 348/143; 348/E07.085

(57) ABSTRACT

A control module for a video surveillance device comprises a sensor detecting the movement of the video surveillance device and generating detection data; and a microprocessor receiving the detection data via an analog/digital conversion circuit, analyzing the detection data, controlling the output of an alert signal according to an analysis result of the detection data, and calculating picture-adjusting data according to the analysis result of the detection data, and using the picture-adjusting data to correct the definition of the picture.

### BACKGROUND OF THE INVENTION

1. Field of the Invention

The present invention relates to a control module for a video surveillance device, particularly to a control module, which can automatically detect the abnormal swing of a video surveillance device to remind the definition of the picture needs adjusting.

2. Description of the Related Art

Video surveillance devices are usually arranged in an open space, such as a building, a warehouse or a road intersection. The video surveillance device not only can persistently monitor the space but also can record the abnormalities, whereby the patrol manpower is saved.

There are blind spots for a fixed-type video surveillance device. Therefore, a cruise-type video surveillance device, which can swing to and fro periodically, is developed to eliminate the blind spots.

The current video surveillance device can detect and solve the problem that the image disappears or the camera is shielded, but cannot detect the abnormal displacement of the camera. Thus, the current video surveillance device may monitor a wrong target and thus lose the security function.

For example, strong wind may cause the abnormal vibration of a video surveillance device and blur the image, which should greatly degrade the performance of the device. Sometimes, wicked persons may shift the direction of a video surveillance device to escape being detected, which also makes the device become useless.

### SUMMARY OF THE INVENTION

One objective of the present invention is to provide a control module for a video surveillance device, which can send out an alert signal and present related information on the picture when the video surveillance has an abnormal movement.

Another objective of the present invention is to provide a control module for a video surveillance device, which can automatically adjust the definition of the picture according to the intensity of vibration.

The present invention proposes a control module for a video surveillance device, which comprises a sensor detecting the movement of the video surveillance device and generating detection data; an assembly element receiving the input video signal from the video surveillance device; and a microprocessor receiving the detection data via an analog/digital conversion circuit, analyzing the detection data, controlling the output of an alert signal according to an analysis result of the detection data, and controlling the output video signal, which is to be output via the assembly element. The sensor may be a gyroscopic sensor, a rotation sensor, a displacement sensor, or a 2-D sensor.

The sensor may be installed in a fixed-type video surveillance device. When the fixed-type video surveillance device, which should be static, has a movement, the microprocessor sends out an alert signal and presents related information on the picture. The sensor may be installed in a cruise-type video surveillance device. When the cruise-type video surveillance device, which should swing at a given speed, stops swinging or swings at an abnormal speed, the microprocessor sends out an alert signal and presents related information on the picture.

The microprocessor also calculates picture-adjusting data according to the analysis result and adjusts the picture according to the picture-adjusting data.

The microprocessor connects with an external communication cable to communicate with external devices, whereby the microprocessor can output data to the external devices, or the external devices can adjust or control the microprocessor.

The present invention is characterized in that the control module can send out an alert signal and present related information on the picture when a fixed-type video surveillance device has a movement or when a cruise-type video surveillance device has an abnormal swing speed or stops swinging.

The microprocessor uses the detection data to calculate the vibration speed of the video surveillance device and fast attain the required compensation value and the picture-adjusting data to optimize the picture. Then, the microprocessor adjusts the output video signal according to the picture-adjusting data. In other words, the microprocessor performs compensative inhibition to optimize the picture according to the direction and intensity of the up-and-down and left-and-right vibrations. The control module of the present invention may be electrically connected with an existing video surveillance device but structurally independent from the video surveillance device. The control module of the present invention may be alternatively installed in the circuit module of a video surveillance device. Besides, the control module of the present invention would not affect the function and performance of the existing video surveillance device.

### BRIEF DESCRIPTION OF THE DRAWINGS

FIG. 1 is a block diagram schematically showing that a control module according to the present invention is electrically connected with a video surveillance device but structurally independent from the video surveillance device; and

FIG. 2 is a block diagram schematically showing that a control module according to the present invention is integrated with the circuit module of a video surveillance device.

### DETAILED DESCRIPTION OF THE INVENTION

The technical contents of the present invention are described in detail with the embodiments. However, it should be understood that these embodiments are only to exemplify the present invention but not to limit the scope of the present invention.

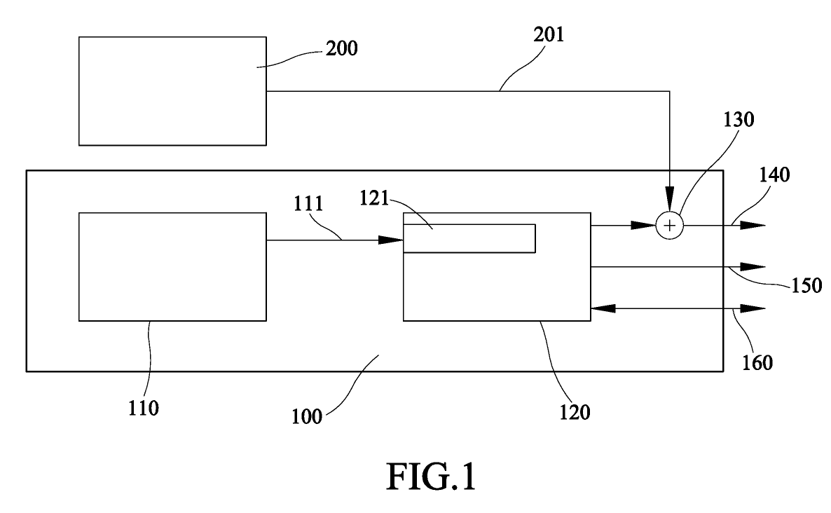

Referring to FIG. 1, the present invention discloses a control module 100 applying to a video surveillance device 200. The control module 100 comprises a sensor 110 detecting the movement of the video surveillance device 200 and generating detection data 111; an assembly element 130 receiving the input video signal 201 from the video surveillance device 200; and a microprocessor 120 receiving the detection data 111 via an analog/digital conversion circuit 121, analyzing the detection data 111, controlling the output of an alert signal 150 according to an analysis result of the detection data 111, and controlling the output video signal 140, which is to be output via the assembly element 130. The sensor 110 may be a gyroscopic sensor, a rotation sensor, a displacement sensor, or a 2-D sensor.

The sensor 110 is used to detect the movement of the video surveillance device 200. The sensor 110 may be installed in a fixed-type video surveillance device 200. When the fixed-type video surveillance device 200 has a movement, the microprocessor 120 analyzes the detection data 111 generated by the sensor 110 to determine the type of abnormality, such the variation of the viewing field. Then, the microprocessor 120 sends out an alert signal 150 and controls the output video signals 140 to present related information on the picture to alert the security personnel.

The sensor 110 may be installed in a cruise-type video surveillance device 200. When the cruise-type video surveillance device 200, which should swing at a given speed, stops swinging or swings at an abnormal speed, the microprocessor 120 analyzes the detection data 111 generated by the sensor 110 to determine the type of abnormality, such the variation of the viewing field. Then, the microprocessor 120 sends out an alert signal 150 and controls the output video signals 140 to present related information on the picture to alert the security personnel.

The sensor 110 can detect the vibration of the video surveillance device 200. When the video surveillance device 200 is rocked by an external factor (such as wind), the microprocessor 120 uses the detection data 111 generated by the sensor 110 to calculate picture-adjusting data. In other words, the microprocessor 120 performs compensative inhibition to optimize the picture according to the direction and intensity of the up-and-down and left-and-right vibrations. The microprocessor 120 uses the picture-adjusting data to modulate the input video signal 201 received by the assembly element 130 to increase the definition of the picture the output video signal 140 presents.

The microprocessor 120 connects with an external communication cable 160 to communicate with external devices, whereby the microprocessor 120 can output data to the external devices, or the external devices can adjust or control the microprocessor 120.

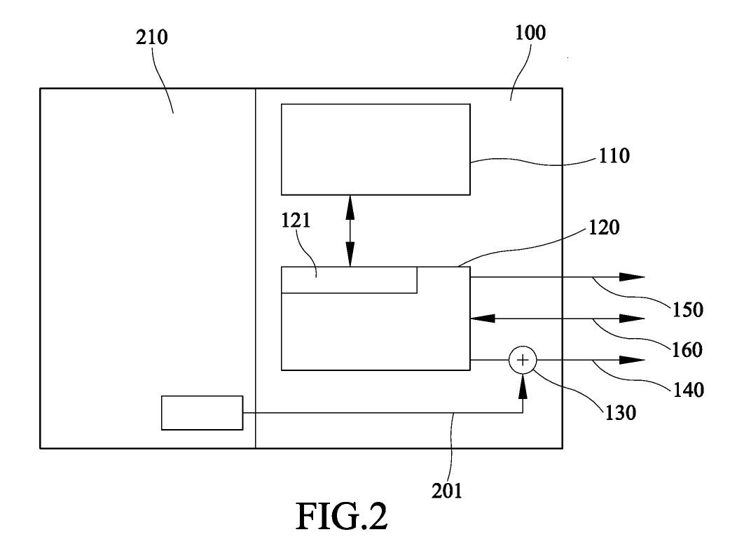

Referring to FIG. 2, the control module 100 of the present invention may be directly installed in the video surveillance circuit 210 of the video surveillance device 200, wherein the input video signal 201 generated by the video surveillance device 200 is also introduced into the control module 100 by the assembly element 130.

The present invention uses the sensor 110 to detect the variations in various directions. When the variation exceeds the normal range, the present invention sends out an alert signal. When the fixed-type video surveillance device 200, which should be static, has a movement, the control module 100 sends out an alert signal and presents related information on the picture. When the cruise-type video surveillance device 200, which should swing at a given speed, stops swinging or swings at an abnormal speed, the control module 100 sends out an alert signal and presents related information on the picture.

When the variation does not exceed the normal range, the microprocessor 120 can use the detection data 111 to calculate the vibration speed of the video surveillance device 200 and fast attain the required compensation value and the picture-adjusting data as shown in FIG. 1. Then, the microprocessor 120 performs compensative inhibition to optimize the picture. The control module 100 of the present invention may be electrically connected with an existing video surveillance device 200 but structurally independent from the video surveillance device 200. The control module 100 of the present invention may be alternatively installed in the video surveillance circuit 210 of the video surveillance device 200. Besides, the control module 100 of the present invention would not affect the function and performance of the existing video surveillance device 200.

The embodiments described above are only to exemplify the present invention but not to limit the scope of the present invention. Any equivalent modification or variation according to the spirit of the present invention is to be also included within the scope of the present invention.

What is claimed is:

1. A control module for a video surveillance device, comprising
a sensor detecting a movement of a video surveillance device and generating detection data;
an assembly element receiving an input video signal from said video surveillance device; and
a microprocessor receiving said detection data via an analog/digital conversion circuit, analyzing said detection data, controlling output of an alert signal according to an analysis result of said detection data, and controlling an output video signal, which is to be output via said assembly element.

2. The control module for a video surveillance device according to claim 1, wherein said microprocessor calculates picture-adjusting data according to said analysis result of said detection data and modulates said output video signal according to said picture-adjusting data.

3. The control module for a video surveillance device according to claim 1, wherein said sensor is a gyroscopic sensor, a rotation sensor, a displacement sensor, or a 2-dimensional sensor.

4. The control module for a video surveillance device according to claim 1, wherein said microprocessor connects with an external communication cable to communicate with external devices.

5. The control module for a video surveillance device according to claim 1, wherein said sensor is installed in a fixed-type video surveillance device; when said fixed-type video surveillance device has a movement, said microprocessor sends out said alert signal and presents related information on a picture.

6. The control module for a video surveillance device according to claim 1, wherein said sensor is installed in a cruise-type video surveillance device; when said cruise-type video surveillance device stops swinging or swings at an abnormal speed, said microprocessor sends out said alert signal and presents related information on a picture.
